(19) United States
(12) Patent Application Publication
(10) Pub. No.: US 2017/0350960 A1
(43) Pub. Date: Dec. 7, 2017

(54) A SPORTS OBJECT AND A SYSTEM FOR TRACKING A SPORTS OBJECT

(71) Applicant: LOST PROPERTY PTY LTD, Subiaco, Western Australia (AU)

(72) Inventor: Ben McCarthy, Doubleview (AU)

(73) Assignee: LOST PROPERTY PTY LTD, Subiaco, Western Australia (AU)

(21) Appl. No.: 15/542,421

(22) PCT Filed: Jan. 8, 2015
(86) PCT No.: PCT/AU2015/050002

§ 371 Date: Jul. 8, 2017

(30) Foreign Application Priority Data
Jan. 8, 2014 (AU) 2014900055

(51) Int. Cl. G01S 5/02; G01S 5/00; G01S 5/14

(52) U.S. Cl. CPC G01S 5/0294; G01S 5/14; G01S 5/0036; G01S 5/0252

(57) ABSTRACT

A sports object comprises an electronic circuit having a power source and a transmitter and arranged to transmit a signal identifying the sports object. The sports object has an inner core encapsulating the electronic circuit. The inner core is configured such that the inner core and electronic circuit are balanced. There is at least one outer core layer encapsulating the inner core. The sports object is used in a system for providing sports game information. The system comprises the sports object and a portable computing device including a receiver responsive to the signal and a location means for determining the location of the computing device. The computing device records the signal received at two or more different locations and records the location of the computing device at each of the different locations to enable estimation of a location for the sports object identified by the received signal.

### FIELD OF THE INVENTION

This invention relates to the sports games that use a ball or other sports object, such as golf or football, or other games, and tracking the sports object.

### BACKGROUND

The game of golf is played in most countries around the world with an estimated 850 million-1,000 million balls manufactured each year. The majority of these balls are multilayered high-density balls which have been made in substantially the same way since the mid-1990s.

A significant proportion of these balls become lost during play. For example, if a player hooks or slices the ball during a stroke the ball may land in the rough and become lost. Similarly, balls can be lost in sand traps or in water hazards.

Losing a ball disadvantages a player by incurring penalty strokes for each lost ball and the cost of replacing the ball. In addition, there is the time spent in searching for a lost ball. If playing socially, it is not uncommon for players to help search for each other's last ball. At present, however, there is no way for players to coordinate their search efforts to improve the likelihood of locating a lost ball. It has been proposed to use a GPS receiver in a golf ball to track its location, such as in US20050101411. However the physical size of the GPS receiver and its power demands has meant that this is not practical. RF range-finding has also been proposed in U.S. Pat. No. 6,113,506, but this is impractical as it requires a dedicated analogue receiving device.

A round of golf is typically played by 2 to 4 players. Arranging a game of golf can typically involves several iterations of phone calls and messages to coordinate a suitable time for a group of players.

Also in golf and other sports, the ball (or other sports object, such as a puck) is the focus of the game. Obtaining data related to location and movement of the sports object is desired, but currently unachievable to the desired level.

The present invention has been developed in light of this background.

Any reference to prior art documents is not an admission that they form part of the common general knowledge of a skilled person in any jurisdiction.

In this specification the terms “having”, “comprising” or “comprises” are used inclusively and not exclusively or exhaustively.

### SUMMARY OF THE INVENTION

According to the present invention there is provided a sports object comprising; an electronic circuit having a power source and a transmitter, the circuit arranged to transmit a signal identifying the sports object,

an inner core encapsulating the electronic circuit so as to provide impact force dampening to the inner core, wherein the inner core is configured such that the inner core and electronic circuit are balanced; and

at least one outer core layer encapsulating the inner core.

In an embodiment the electronic circuit, further comprises an accelerometer. In an embodiment the accelerometer or data from the accelerometer is calibrated or able to be calibrated to account for the force dampening of the inner core. In an embodiment the accelerometer provides data for transmission by the electronic circuit.

In an embodiment the signal identifying the sports object and data from the accelerometer are digitally encoded for transmission by the electronic circuit.

In an embodiment the transmitter comprises a bluetooth transmitter. In a further embodiment the transmitter comprises a bluetooth low energy module.

In an embodiment the power source comprises a battery.

In an embodiment the circuit is arranged to enter a low power state after a period of inactivity.

In a further embodiment the circuit is arranged to wake from the low power state after receiving, a wake-up signal. In a further embodiment the wake up signal is an accelerometer reading exceeding a threshold level.

In an embodiment the inner core includes at least one cavity positioned such that the inner core and circuit have a substantially balanced centre of mass.

In an embodiment the electronic circuit excludes processing other than necessary to transmit the digitally encoded signal and data from the accelerometer.

In an embodiment the electronic circuit determines a signal strength from a signal received from a transmitter of a device and includes the signal strength in data transmitted by the electronic circuit.

In an embodiment the electronic circuit excludes processing other than necessary to transmit the digitally encoded signal, data from the accelerometer and signal strength from the device transmitter.

According to the present invention there is provided a system for providing sports game information comprising:

a sports object, wherein the sports object includes an electronic circuit having a power source and a transmitter, the circuit arranged to transmit a signal identifying the sports object;

a portable computing device including a receiver responsive to the signal and a location means for determining the location of the computing device, wherein the computing device records the signal received at two or more different locations and records the location of the computing device at each of the different locations to enable estimation of a location for the sports object identified by the received signal.

In an embodiment there is at least one sports object for each player.

In an embodiment there is a portable computing device for each player.

In an embodiment the portable computing device estimates the location for the sports object from the recorded two or more records of the signal received at the different locations and the recorded locations of the computing device at each of the different locations.

In an embodiment the portable computing device transmits the recorded two or more recorded signals received at the different locations and the recorded locations of the computing device at each of the different locations to another device so that the other device can estimate the location for the sports object from the recorded at least two instances of the signal received at the different locations and the recorded locations of the computing device at each of the different locations.

In an embodiment there are a plurality of portable computing devices, each of which is able to receive a signal from the or each sports object, and each computing device records at least one instance of the signal received, wherein each computing device is at a different location, wherein the signals received by each computing device and the location of each computing device is enable to be used to compute an estimation of a location for the sports object.

In an embodiment the signal transmitted by the sports object includes a signal strength indicator. In an embodiment the signal strength indicator is the signal strength of a signal received by the sports object from the portable computing device.

In an embodiment the computing device associates a location of computing device with a signal from the sports object received at that location, wherein the estimate of a location for the sports object is determined by triangulation from at least two associated locations of the portable computing device, movement of the portable computing device and signals from the sports object.

In an embodiment the computing device displays the location of that player's sports object location overlaid on a map of a course or playing field.

In an embodiment the sports object includes an accelerometer, wherein the signal includes accelerometer information, wherein the computing device receives the accelerometer information and displays a trajectory and approximate location of the ball based on accelerometer information.

In an embodiment the computing device is arranged to track plural sports objects, including those of the player and of other players.

In an embodiment a plurality of computing devices are arranged to track a single sports objects and the position of each computing device. In an embodiment each player holds or wears a portable computing device. In an embodiment one or more non participates may each have a portable computing device, each of which sends information received form the sports object and the location of the respective computing device to a central tracking system. In an embodiment the tracking information is transmitted from each computing device to a central tracking system configured to track all of the players and the sports object. In an embodiment the tracking system using information from a plurality of computing devices and or a plurality of transmissions from the same computing device at different locations to increase the accuracy of the estimated location of the or each sports object.

In an embodiment the computing device stores entered score information from the player. In an embodiment the computing device is configured to determine a score for the player based on information derived from the accelerometer and or the location of the sports object.

In an embodiment the system further comprises a computer server in communication with each computing device via a communications network, wherein the computing device is configured to transmit to the computer server sports object location information. In an embodiment the computing device is transmits to the computer server sports object accelerometer reading information. In a further embodiment the computing device transmits score information to the computer server.

In an embodiment the computer server stores game information and sports object location information from each player in a data store.

In an embodiment, the computing device receives game invitations entered by the player and communicates them to the computer server. In a further embodiment, the computer server stores received the game invitations and communicates the invitations to each invited player's computing device.

In an embodiment, the computing device receives game invitation responses entered by an invited player and communicates them to the computer server. In a further embodiment, the computer server stores the received game invitation responses and communicates the responses to the computing device of the player issuing the invitation.

In an embodiment, the computing device displays responses to invitations to the player issuing the invitation, wherein upon entry of a booking instruction from the player the computing device communicates said booking instruction to the computer server. In a further embodiment, the computer server receives a booking instruction from a computing device and transmits a booking message to a stored address corresponding to a place as which the game is to be played in the booking instruction.

In an embodiment the computing device is configured to display the location of the or each sports object on a map of the sports game play area. In an embodiment the computing device is configured to display the location of the computing device associated with a player on a map of the sports game play area. In an embodiment the computing device is configured to display the location of the or each player on a map of the sport game play area. In an embodiment the computing device is configured to display historic locations of the sports object on the map. In an embodiment the computing device is configured to display historic locations of the players on the map.

In an embodiment the computing device is configured to share the received information from the sports object with another computing device. In an embodiment the computing device is configured to share the information with the other computing device without itself using the information.

In an embodiment the computing device is configured to receive shared information received from the sports object by another computing device and to use the shared information in tracking the sports object.

According to the present invention there is provided a system for providing sports game information comprising:

a sports object, wherein each sports object includes an electronic circuit having a power source and a transmitter, the circuit arranged to transmit a signal identifying the sports object;

a plurality of portable computing devices, each including a receiver responsive to the signal and a location means for determining the location of the computing device, wherein each computing device records the signal received and records its location, wherein the recorded signals and recorded locations of the computing devices enable estimation of a location for the sports object identified by the received signals.

According to the present invention there is provided a portable computing device for providing sports object tracking information comprising:

an input for receiving a signal including an identifier and a signal strength indicator from a sports object;

a further input for receiving a location for a computing device;

a record processor arranged to store a plurality of records in a data store, each record comprising the identifier, signal strength indicator and computing device location, wherein the record processor is further arranged to process records in the data store to calculate an estimated location for the sports object and to display the estimated location.

In an embodiment computing device is configured to share the record with another computing device.

In an embodiment the computing device is configured to receive a shared record from another computing device, which record comprises the identifier, signal strength indicator from the sports object and computing device location of the sharing device, wherein the shared record is then able to be used to calculate the estimated location for the sports object.

In an embodiment the record processor calculates the estimated location by triangulation from at least two records.

In an embodiment the record processor displays the location of the respective sports object's location overlaid on a map of a play area.

In an embodiment the record processor displays historic locations of the sports object's location on the map.

In an embodiment the signal include accelerometer information from the sports object, wherein the record processor is arranged to store the accelerometer information in the record.

In an embodiment the computing device further comprises a score input for receiving score information from a player.

According to the present invention there is provided a computer program for controlling a portable computing device to provide sports object tracking information, the computer program comprising instructions for controlling the computing device to:

receive a signal including an identifier and a signal strength indicator from a sports object;

receive a location for a computing device;

store a plurality of records in a data store, each record comprising the identifier,

signal strength indicator and computing device location, and

process records in the data store to calculate an estimated location for the sports object and to display the estimated location.

According to the present invention there is provided a system for tracking a sports object comprising:

an electronic circuit inside the sports object, the circuit having a transmitter arranged to transmit a short range signal for identifying the sports object;

a plurality of positional devices, each having a receiver able to receive the signal when the sports object is within range, each positional device being positioned at a different location on a play area and being able to communicate with a portable computing device;

wherein the positional devices are each configured to determine whether the sports object is within range by it receiving the signal from the sports object and when the sports object is within range to communicate this to the portable computing device, such that the portable computing device can track the sports object.

In an embodiment the positional devices are positioned on the play area to enable at least two tracking devices to be within range when the sports object is on the play area. Preferably the positional devices are positioned on the play area to enable at least three tracking devices to be within range when the sports object is on the play area.

In an embodiment the positional devices communicate with the portable computing device via a server device.

In an embodiment the positional devices communicate a distance or a directional signal to the server device. In an embodiment the distance signal is determined from a signal strength of the signal from the sports object as received by the respective tracking device.

In an embodiment the server device is arranged to calculate the position of the sports object from the distance or directions signals.

In an embodiment the server device is arranged to send the position of the sports object to the portable computing device.

In an embodiment the portable computing device is arranged to display the position of the sports object on a map.

According to the present invention there is provided a sport play area for tracking a sports object comprising:

a plurality of positional devices, each having a receiver able to receive a short range signal from a sports object when the sports object is within range, each positional device being positioned at a different location on the play area and being able to communicate with a portable computing device;

wherein the positional devices are each configured to determine whether the sports object is within range by it receiving the signal from the sports object and when the sports object is within range the positional devices are each configured to communicate this to the portable computing device, such that the portable computing device can track the sports object.

### DESCRIPTION OF ACCOMPANYING DRAWINGS

In order to provide a better understanding, example embodiments of the present invention will now be described with reference to the accompanying drawings, in which:

FIG. 1 is a block diagram of the system according to one embodiment of the invention;

FIG. 2 is a schematic diagram of one hole of a golf course according to an embodiment of the present invention; and

FIG. 3 is a schematic diagram of a server of an embodiment of the present invention.

### DESCRIPTION OF EXAMPLE EMBODIMENTS

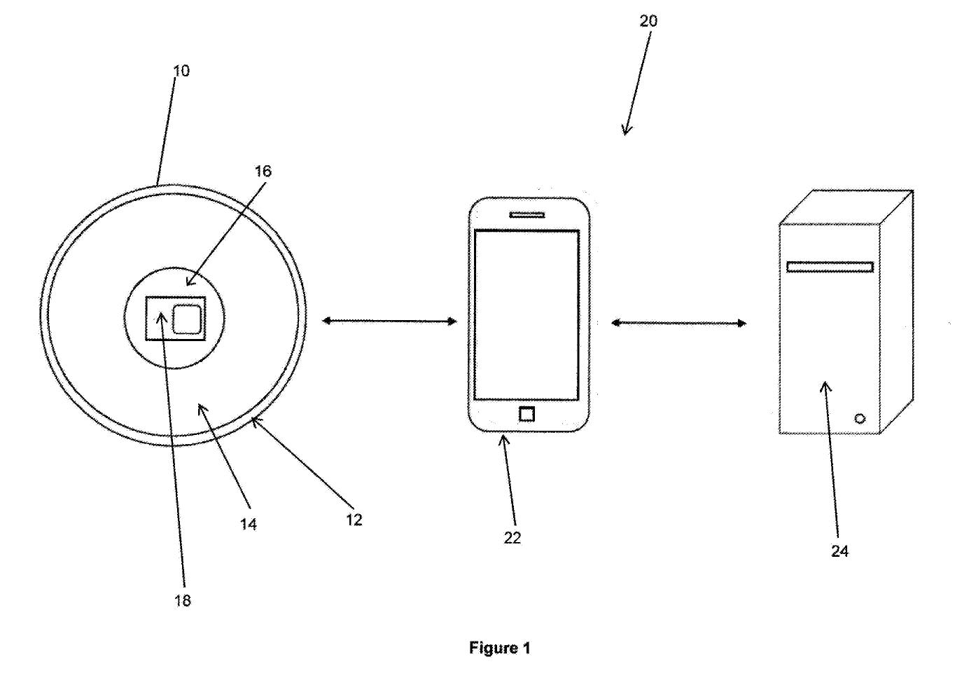

Referring to FIG. 1 there is shown in cross-section a sports object, in this case a golf ball 10 according to one embodiment of the invention. The golf ball 10 comprises a cover 12, an outer core 14, and an inner core 16 which encases an electronic circuit 18. It will be understood that other types of sports object may be applicable to the present invention, such as a football, baseball, basketball, hockey ball, cricket ball, or hockey puck. For solid sports objects, the main difference is the size, external appearance of the cover 12 and the nature of the outer core 14, which will differ according to the specific type of sports object. For inflatable sports objects, there is the additional difference of an inflatable bladder either between the inner core 16 and the outer core 14 or between the outer core 14 and the cover 12. Alternatively the inner core 16 may be attached a wall of the cover 12, outer core 14 or bladder.

The electronic circuit 18 comprises a power supply and radio circuit including a transmitter and a receiver. In the embodiment, the power supply comprises a battery and the radio circuit comprises a low energy Bluetooth radio module that is, for example compliant with Bluetooth specification 4.0, or subsequent specification. Detailed specifications on low energy Bluetooth radio modules can be found at the Internet address: “https://www.bluetooth.org/en-us/specification/adopted-specifications” the contents of which are incorporated herein by reference.

In practice off the shelf Bluetooth radio circuits may have a transmit range that is less than theoretically possible. An RF signal amplifier may be included between a transmitter of the radio circuit and an antenna. In the case of using Bluetooth radio circuit the amplifier shall be configured to amplify signals in the 2.4 GHz band.

Each Bluetooth radio module has a unique identifier digitally encoded in the transmitted signal, which can be used as the identifier of the sports object.

In one embodiment, the electronic circuit 18 further comprises an accelerometer interfaced with the Bluetooth radio circuit so that accelerometer information is digitally encoded and transmitted by the Bluetooth radio module. The accelerometer may also be used to put the electronic circuit 18 into a low-power state whenever signals from the accelerometer are below a threshold value for a predetermined period of time indicating that the golf ball 10 is in a state of inactivity. Similarly, the electronic circuit 18 is awakened from its low-power state by the presence of a wake-up signal defined by signals from the accelerometer above a threshold level, indicating movement of the golf ball 10.

In an embodiment measurements from the accelerometer as suitable for measuring one or more of the following: impact force to the sports object (such as the striking force by a club or bat or from a kick etc.), flight characteristics of the sports object (such as spin or wobble, velocity of the sports object), subsequent impact (such as bouncing), trajectory characteristics (such as direction of travel or height change) and/or attaining rest. The accelerometer measurements will typically be sampled as an appropriate capture rate, such as at a frequency of 1 sample per millisecond, and then stored for download periodically, or once a connection to a computing device is established. The accelerometer will typically measure acceleration applied to the accelerometer in three orthogonal axes. This will enable three dimensional measurement which can be used to determine movement type, such as stroke/hit, kick, hand-ball, bounce, and quality of hit or handling (whether the ball is hooked or sliced, squarely hit, slippage, fumbling etc.).

In the embodiment, for a golf ball, the inner core 16 is approximately 25 mm in diameter and encases the electronic circuit 18. The inner core 16 is weighted and balanced so that it does not affect the overall mass or performance of the golf ball 10. An important consideration is the centre of mass of the golf ball 10, and as such the inner core 16 may include one or more cavities (not shown) or one or more high-density areas (not shown) to balance the mass of the electronic circuit 18.

In one embodiment, the inner core 16 is formed of impact shock absorbing soft material. In an alternative embodiment, inner core 16 may be formed of solid composite material. In an embodiment the accelerometer or data from the accelerometer is calibrated or able to be calibrated to account for the force dampening of the inner core. In an embodiment the accelerometer provides data for transmission by the electronic circuit.

The outer core 14 is formed of a high density composite material typically used in the manufacture of golf balls, such as urethane or surlyn resin available from DuPont Company.

The sports object 10 also forms part of a system 20 for providing information and for locating the sports object. In this embodiment, the system 20 further comprises one or more portable computing devices 22 and a computer server 24.

Typically, each player in a game of golf that is using a golf ball 10 will have their own portable computing device 22. Conveniently, the portable computing device 22 may take the form of a smart phone, tablet computer or other similar device having a location system to geographically locate the computing device 22.

Examples of suitable location systems include global positioning system (GPS) receiver or a cellular telephone location system based on received signal strength from nearby base stations.

In another form for a team sport, the portable computing device may be in the form of a GPS tracking device worn by a player, with an enhancement so as to be able to receive the signal transmitted from the sports object and to retransmit it to the computer server 24 along with the GPS determined location of the player.

In the golf example, each player associates their golf ball 10 with their portable computing device 22 such that the portable computing device 22 receives the signal transmitted by the electronic circuit 18.

The portable computing device 22 executes a software application which receives and processes the signal from the golf ball 10 to estimate the location of the sports object 10. The signal transmitted by the electronic circuit 18 includes a unique identifier of the sports object and may include signal strength information which is used by the computing device 22 to identify the sports object and to estimate a distance from it to the sports object 10, respectively. In particular the power of the signal received may be used as a received signal strength indicator (RSSI) for approximating the distance of the transmitter in the ball to the receiver of the computing device. The RSSI may be implemented in a similar manner to that implemented in the 802.11 standard. As multiple signals are received from the sports object 10, a more precise bearing in distance from the portable computing device 22 can be ascertained.

In an embodiment the signal strength indicator is the signal strength of a signal received by the sports object 10 from the portable computing device 22.

Further the signal strength of the signal form the sports object 10 received by the portable computing device 22 may be used to determine the distance of the sports object 10 to the computing device 22. In the case of an amplifier being used to boost the RF signal sent by the sports object, the amplification may need to be taken in to account in determining the signal strength used to determine the distance.

The computing device 22 utilises its location system to geographically locate the computing device 22 and this location is then stored with the signal from the golf ball as a record in a data stare of the computing device 22. By processing plural records and determining from each the relative location of the golf ball 10 to the computing device 22 and the geographic location of the computing device 22 a geographic location of the golf ball 10 can be calculated. In one embodiment, this location is displayed to the user overlaid on a geographic map of the area, such that they can see the location of the ball on a golf course.

In other sports, there may be only one active sports object (e.g. a ball) and the location of each of the player's portable computing devices along with the respective received signal strength from the sports object are collectively used to determine the location of the sports object.

With many signals received the location accuracy can be increased. For example a first portable computing device receives a signal which indicated the sports object is 5 m away with an accuracy of plus or minus 1 m. A second portable computing device receives a signal which indicated the sports object is 6 m away with an accuracy of plus or minus 1 m. Once the positions of each portable computing, device is known (such as from the GPS location of each device) intersections of these distances can determine one or two possible locations. Other information, such as historic information may mean there is only one possible location, but the accuracy of each signal will still leave the position to be determined with only a low level of precision (i.e. the position must take into account the two error factors, meaning it can only be determined accurately with a low precision). If an additional measurement is taken, either from another device, or from a subsequent signal received (perhaps from a different location) from the same device, then the precision of the determined location can be increased. Obviously additional readings will further increase the precision of the determined location and thus the determined location can be considered to be more accurate, i.e. it is more precise with a lower error factor.

In an embodiment the computing device may be configured to share the information with the other computing device without itself using the information. In this embodiment the location of another player's ball can be determined with assistance, but the assisting computing device does not itself determine the location of the ball. This would not preclude the location of the ball once determined to be shared with the assisting computing device if the player whose ball was located enabled this sharing.

In one embodiment, the electronic circuit 18 also transmits accelerometer information. When received, the computing device 22 or server 24 processes the accelerometer information to calculate, for example, a trajectory, speed. Spill and friction of the sports object so as to derive a path of the ball, for instance during flight after being struck. The flight path of the sports object can then be displayed to the player on the computing device 22, for example by being overlaid on a geographic map of the area, so for example a player can see their stroke paths on the golf course or a spectator can see the position of the ball on a field of a football game. In an example the map may take the form of an aerial image provided by or integrated with other GPS mapping applications of a mobile telephone.

If the player should strike the golf ball 10 such that it enters a rough or a sand trap and is difficult to locate, the player can use the computing device 22 to assist them in locating the golf ball 10. As the player walks to where they saw the golf ball 10 travel, the computing device 22 enters the transmit range of the golf ball 10 and begins receiving the signal transmitted by the electronic circuit 18. As the player moves around, searching for the golf ball 10, the location of the computing device 22 is tracked by its location system which, combined with the signals received from the golf ball 10, enables an accurate estimate of the golf ball 10's location to be displayed to the user on the portable computing device 22.

A player's ball handling skills and game play tactics can be analysed with greater accuracy for using in coaching purposes for example.

The computing device 22 communicates with the computer server 24 via an existing communications networks such as a mobile telecommunications network. WiFi network and an Internet communications network. The computing device 22 communicates the location of the sports object 10 to the computer server 24.

The computer server 24 stores the location of the sports object 10 in a record associated with the sports object. The sports object may be associated with a specific player, such as in the case of golf. The player can later use the computing device 22 to recall past history of ball locations for a particular golf course as a learning aid.

In addition, the computer server 24 communicates with computing devices of friends of the player who are also playing in the same round of golf, or with coaches or spectator in another game. This communication includes the location information of the sports object 10 from the player's computing device 22. In turn, the server 24 receives from other computing devices additional estimates of the location of the sports object determined in the same manner as described above. The server 24 stores these additional location estimates and communicates them to the computing device 22.

By communicating the location of golf balls estimated by several computing devices, a more accurate location can be found more quickly when trying to locate a lost golf ball. This is particularly important when playing in a game where a time limit imposed on searching for lost balls, at the end of which penalty strokes are incurred.

The computer server 24 may maintain ladders of the performance of the players, such as the most played, most improved, and lowest scores and handicap.

The computer program executing on each computing device 22 may include a scorecard where each stroke taken by the player can be recorded and assessed against the par score for each hole and the course. In one embodiment, the computer program enables the score of all the players in the round of golf to be recorded.

In an embodiment the computing device 22 is configured to automatically determine a score for the player based on information derived from the accelerometer and or the location of the sports object. For example if the ball is determined to enter a goal area, a point may be scored in a game of soccer, or the number of strokes taken may be recorded in a game of golf.

Further, the computer server 24 enables players to issue game invites to friends for a round of golf, book courses and schedule games of golf into the calendars of players who accept an invitation by communicating with the computing device of each of the players. In the case of booking courses, the computer service will indicate to the stored booking address for each golf course, such as an email address.

In one embodiment, the computer program executing on each computing device 22 includes a chat function enabling messages to be sent between players during a game.

In one embodiment, the computer program executing on each computing device 22 includes sharing functions enabling the player to share their score and other messages with social media platforms using the application program interface (API) of those platforms. In other embodiments, the computing device 22 sends a request to post to a social media platform to the computer server 24 in response to which the computer server 24 communicate with the API of the social media platforms.

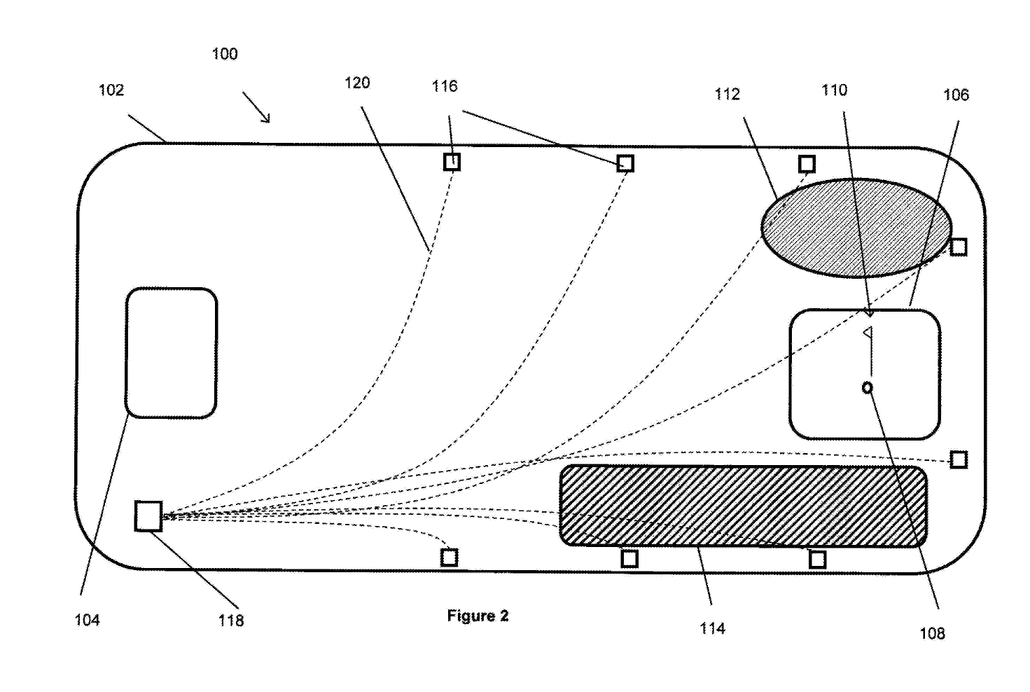

In one embodiment, represented schematically in FIG. 2, additional positioning devices 116 maybe located at fixed positions around a range 100 of play area, which in this example is a golf course or driving range. Each of the devices 116 is positioned along a length 102 of the range 100 between a teeing ground 104 and a putting green 106. A water trap 112 and a rough 114 are schematically shown on either side of the putting green 106. The devices 116 are connected (by wire 120 or wirelessly) to a local server 118, which in turn is connected to the server 24 via a network connection. This enables the devices 116 to communicate with the computer server 24. These additional computing devices 116 are arranged to receive signals from any sports object and to communicate them to the server 24. The server 24 then communicates the position estimates from the fixed computing devices 116 to the computing device 22 of the player associated with the sports object identifier to assist in locating the sports object between strokes or during play. In an alternative the devices 116 may be simpler receivers for receiving a signal from a sports abject and computing 118 interprets these signals and communicates them to the server 24 or portable computing device 22.

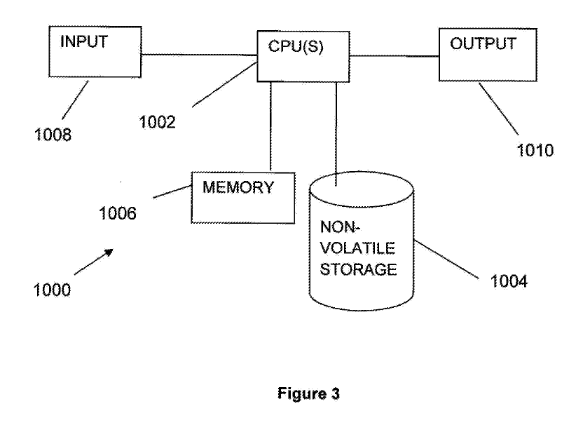

Referring to FIG. 3 a portable computing device 1000 is shown in more detail. The device 1000 comprises one or more processors 1002 which comprises at least one processor core and memory 1006. The memory may comprise volatile memory 1006, such as DRAM and non-volatile memory 1004, such and flash memory. A computer program or programs will be stored in the non-volatile memory and may be temporarily moved to the volatile memory for execution. The volatile memory may also be used by the processor 1002 for temporary storage of data. Long term data storage is provided by the non-volatile memory.

The processor 1002 controls an output 1010, which may be a display for providing visual information to a user. The processor 1002 also receives in formation from an input 1008, which includes a user interface, such as a touch screen, the Bluetooth interface and a location module, such as a GPS system module. The processor 1002 also has a cellular telephone communication module 106 and a wireless network, communication module 108. The cellular telephone communication module and a wireless network communication module are as is standard in a mobile phone.

In one embodiment the processor 1000 is provided by an operating system and application software for controlling the operation of the device 1000. In particular the software is configured to control the device 100 to operate as described above. In other embodiments some or the entire configuration of the processor 1000 may be implemented in hardware, firmware or one or more computer programs executed by the processor 1000. The computer program configures the processor to operate according to one of more of the methods described above.

Modifications and variations as would be apparent to a skilled person are intended to fall within the scope of the present invention.

1.-9. (canceled)

10. A system for providing sports game information comprising:
a sports object, wherein the sports object includes an electronic circuit having a power source and a transmitter, the circuit arranged to transmit a signal identifying the sports object;
a portable computing device including a receiver responsive to the signal and a location means for determining the location of the computing device, wherein the computing device records the signal received at two or more different locations and records the location of the computing device at each of the different locations to enable estimation of a location for the sports object identified by the received signal.

11. (canceled)

12. A system according to claim 10, wherein there is a portable computing device for each player, wherein the portable computing device of each player is configured to receive the signal from the or each sports object and exchange information in the or related to each respective received signal.

13. A system according to claim 10, wherein the portable computing device estimates the location for the sports object from the recorded two or more records of the signal received at the different locations and the recorded locations of the computing device at each of the different locations.

14. A system according to claim 10, wherein the portable computing device transmits the recorded two or more recorded signals received at the different locations and the recorded locations of the computing device at each of the different locations to another device so that the other device can estimate the location for the sports object from the recorded at least two instances of the signal received at the different locations and the recorded locations of the computing device at each of the different locations, so that the other device can estimate the location of the sports object from the recorded at least two instances of the signal received at the different locations and the recorded locations of the computing device at each of the different locations along with a signal received from the sports object by the other device.

15. A system according to claim 10, wherein there are a plurality of portable computing devices, each of which is able to receive a signal from the or each sports object, and each computing device records at least one instance of the signal received, wherein each computing device is at a different location, wherein the signals received by each computing device and the location of each computing device is enable to be used to compute an estimation of a location for the sports object.

16. A system according to claim 10, wherein the signal transmitted by the sports object includes a signal strength indicator.

17. A system according to claim 16, wherein the signal strength indicator is the signal strength of a signal received by the sports object from the portable computing device.

18. A system according to claim 10, wherein the computing device associates a location of computing device with a signal from the sports object received at that location, wherein the estimate of a location for the sports object is determined by triangulation from at least two associated locations of the portable computing device, movement of the portable computing device and signals from the sports object.

19. A system according to claim 10, wherein the computing device displays the location of that player's sports object location overlaid on a map of a course or playing field.

20. A system according to claim 10, wherein the sports object includes an accelerometer, wherein the signal includes accelerometer information, wherein the computing device receives the accelerometer information and displays a trajectory and approximate location of the ball based on accelerometer information.

21. A system according to claim 10, wherein the computing device is arranged to track plural sports objects, including those of the player and of other players.

22. A system according to claim 10, wherein a plurality of computing devices are arranged to track a single sports objects and the position of each computing device.

23. A system according to claim 10, wherein the tracking information is transmitted from each computing device to a central tracking system configured to track all of the players and the sports object.

24. A system according to claim 23, wherein the tracking system using information from a plurality of computing devices and or a plurality of transmissions from the same computing device at different locations to increase the accuracy of the estimated location of the or each sports object.

25. A system according to claim 10, wherein the computing device is configured to display the location of the or each sports object on a map of the sports game play area.

26. A system according to claim 25, wherein the computing device is configured to display the location of the computing device associated with a player on a map of the sports game play area.

27. A system according to claim 25, wherein the computing device is configured to display the location of the or each player on a map of the sport game play area.

28. A system according to claim 25, wherein the computing device is configured to display historic locations of the sports object on the map.

29. A system according to claim 27, wherein the computing device is configured to display historic locations of the players on the map.

30. (canceled)

31. A system according to claim 10, wherein the computing device is configured to receive shared information received from the sports object by another computing device and to use the shared information in tracking the sports object.

32. A system for providing sports game information comprising:
a sports object, wherein each sports object includes an electronic circuit having a power source and a transmitter, the circuit arranged to transmit a signal identifying the sports object;
a plurality of portable computing devices, each including a receiver responsive to the signal and a location means for determining the location of the computing device, wherein each computing device records the signal received and records its location, wherein the recorded signals and recorded locations of the computing devices enable estimation of a location for the sports object identified by the received signals.

33. A portable computing device for providing sports object tracking information comprising:
an input for receiving a signal including an identifier and a signal strength indicator from a sports object;
a further input for receiving a location for a computing device;
a record processor arranged to store a plurality of records in a data store, each record comprising the identifier, signal strength indicator and computing device location, wherein the record processor is further arranged to process records in the data store to calculate an estimated location for the sports object and to display the estimated location.

34.-49. (canceled)
